(19) United States
(12) Patent Application Publication
(10) Pub. No.: US 2012/0318435 A1
(43) Pub. Date: Dec. 20, 2012

(54) POOL COPING AND METHOD FOR FABRICATING

(76) Inventor: Mark Castelluci, SR., Sonoma, CA (US)

(21) Appl. No.: 13/477,725

(22) Filed: May 22, 2012

Related U.S. Application Data
(60) Provisional application No. 61/497,353, filed on Jun. 15, 2011.

(51) Int. Cl. E04H 4/04; B29C 47/00

(52) U.S. Cl. 156/71; 264/489; 264/148

(57) ABSTRACT

Swimming pool coping made of recycled rubber can replace traditional concrete copings. The rubber chips can be mixed with a binder placed in an extrusion machine that pressurizes and heats the mixture to activate the binder. Alternatively, the rubber chips and binder can be placed in a compression mold where the rubber chips are compressed and heated to activate the binder. The rubber coping can then be removed from the extrusion machine or compression mold. The coping is then cooled which hardens and strengthens the coping. The hardened rubber coping is then cut to a predetermined length and shape. The coping can be adhered to the bond beam of the swimming pool and the adjacent coping. A sealer can be applied to the exposed surfaces of the coping to provide color, texture and provide UV protection.

### CROSS REFERENCE TO RELATED APPLICATIONS

This application claims priority to U.S. Provisional Patent Application No. 61/497,353, “POOL COPING” filed Jun. 15, 2011. Then entire contents of U.S. Provisional Patent Application No. 61/497,353 are hereby incorporated by reference.

### BACKGROUND

There are various types of swimming pools including indoors or outdoors. Pools can also be in ground or above ground. The pool can contain a large volume of water includes side and bottom surfaces which can be concrete, fiberglass, or other suitable water proof materials. A concrete pool deck can surround the pool and a concrete coping can be installed at the intersection of the upper pool sides and the horizontal edge of the pool deck.

A problem with swimming pools is that water clings from the swimmers as they exit the pool. The water then falls from the swimmers onto the concrete deck and coping creating a slippery surface. As other people walk over these wet spots, their feet can hydroplane and slip resulting in a fall. A wet slippery flat concrete deck can be very unsafe and a fall on the hard concrete edge of the coping can cause significant injury to people or animals walking by the pool.

Another problem with cement coping is that the installation process uses mortar. The excessive drying and subsequent shrinkage of cement mortar and concrete coupled with concrete coping expansion, can lead to shear failure of the coping. Additionally, the inclusion of expansion joints adjacent to a concrete coping can contribute to a failure. What is needed is an improved coping that improve reduces the potential for injury and has a simplified installation.

### SUMMARY OF THE INVENTION

The invention is directed towards a rubber coping that can be made from rubber chips. In an embodiment, the recycled rubber can be derived from recycled tires. It is estimated that the rubber required to make the coping for an average sized residential pool that can be about 40 feet long by 20 feet wide can be obtained from about 160 to 180 used tires and that 500 tires may be required to make the coping for a very large commercial pool. The rubber coping can be made from 95 to 99% crumb rubber that is mixed with 1 to 5% polymer binder.

In an embodiment, the rubber and binder are mixed and placed in a hopper of an extruding machine that can pressurize the mixture to about 2,000 to 3,000 psi. Within the extruder the rubber and binder can be heated to about 200 to 280 degrees Fahrenheit (F) to activate the binder material which can cause the binder to fuse to the crumb rubber particles together. In an embodiment, the coping pieces can be heated by exposing the coping to microwave energy within the extruder. In other embodiments, other heating methods can be used. The heated and pressurized mixture is forced through a die on the extruder that matches or is slightly larger than the cross section of the finished coping. After or as the coping pieces are extruded the coping pieces can be cut to a uniform length, such as 24 inches. As or after the coping exits the extruder, it can be cut to other uniform or non-uniform lengths. After extrusion, the coping pieces can be cooled to harden the binder and adhered to the rubber particles. After the binder has cooled and hardened, the coping is strong but still elastic with similar mechanical characteristics of a solid piece of rubber.

In another embodiment, the coping pieces can be made with a compression mold. An exact loose volume of the rubber and binder mixture can be placed in a lower mold which can have an open top. Once the lower mold is filled, the upper mold can then be pressed into the lower mold to compress the rubber chips to the final thickness of the coping pieces. The pressure applied by the upper mold can be greater than 250 psi. The rubber and binder can also be heated within the compression mold to about 200 to 280 degrees Fahrenheit (F) to activate the binder material which can cause the binder to fuse to the crumb rubber particles together. After compression molding, the coping pieces can be removed from the mold and cooled to harden the binder and adhered to the rubber particles. The compression molded coping can have similar mechanical characteristics of a solid piece of rubber. If the mold is used to produce rectangular coping pieces, the lower mold can basically be a rectangular recess with side walls that are higher than the finished coping pieces. In other embodiments, curved compression molds can be used to create curved coping pieces.

A swimming pool coping installation may only require rectangular coping pieces if the corners of the pool are square corners. However, if curved coping is required for inside or outside corners as in the case of a radius edged pool, the rectangular rubber coping pieces can be cut at the desired radius to form curved coping pieces. The coping pieces can also have edging cut on the sides. These cut sides will be placed against the side of an adjacent coping in the installation and may look like a grout line, although grout is not used with the inventive rubber coping. The cut rubber coping pieces can be machined to form the nosing on the water side of the coping. The nose can be formed using a CNC router table.

The extruded coping can be installed around the edges of a swimming pool on a concrete bond beam. An adhesive such as a polyurethane binder can be used to attach the coping pieces to the top of the bond beam and to each other. The adhesive can be placed on the top surface of the bond beam and the coping pieces can be set in place around the perimeter of the swimming pool. The adhesive can also be placed on the sides of the coping pieces to glue each coping to the adjacent coping. The installed coping can then be covered with a rubber acrylic sealer that provides UV protection and may also include an ornamental color. The sealer can be applied with an air gun or rollers and will adhere with the bonded rubber substrate of the coping. The sealer can cover and conceal any seams in the rubber coping and create the appearance of a uniform structure.

The installation of the rubber coping is a substantial improvement over the fabrication and installation of concrete coping. In order to make concrete coping, a variety of coping pieces must be made which will match each straight and curved section of the swimming pool edge. The concrete coping pieces are then installed with cap leveling mud, a mortar bed, an expansion joint and grout or caulk which requires.

### BRIEF DESCRIPTION OF THE DRAWINGS

FIG. 1 illustrates a cross section of a rubber coping;

FIG. 2 illustrates a cross section of an edge of a swimming pool having rubber coping;

FIG. 3 is a flow chart of the process steps used to make and install the rubber coping using an extrusion process;

FIG. 4 is a flow chart of the process steps used to make and install the rubber coping using a compression molding process;

FIG. 5 illustrates a top view of extruded rubber cut to form a curved coping piece; and

FIGS. 6A, 6B and 6C illustrate cross sections of different nosings formed on the rubber coping.

### DETAILED DESCRIPTION

The present invention is directed towards an improved pool coping which is made of rubber rather than concrete. The inventive rubber coping has various advantages over the prior art. The rubber coping is an elastic material that is much softer than concrete and able to absorb the impact energy so the impact of a person falling on the rubber coping may cause less injury than if the person fell onto a concrete coping. The hardness and the rigidity of concrete coping can be many times greater than that of rubber coping. Thus, pools that use the inventive rubber coping may dramatically reduce the potential for slip and fall injury compared to concrete coping.

The rubber coping is also significantly lighter than concrete coping. The rubber coping can be about 60% lighter than concrete coping of the same size. The density of concrete can be about 180 pounds per cubic foot and the density of rubber can be about 74 pounds per cubic foot. Thus, a coping piece that is 24 inches long, 14 inches wide and 3 inches thick can have a volume of about 0.583 cubic feet. Thus, this coping made of concrete can weigh about 105 pounds. In contrast, this same coping made of recycled rubber can weigh about 43.2 pounds. The lighter weight of the rubber coping will reduce the transportation and shipping costs and make manual handling much easier. The rubber coping is also flexible will also not crack or is less likely to cause damage if dropped, unlike traditional concrete coping.

Another benefit of the rubber coping is that it can have a textured finish that provides better wet traction than a smooth wet concrete coping. Yet another benefit is that the rubber material used to make the rubber coping can be recycled from various scrap rubber goods including car tires. Thus, the recycled rubber can be used rather than being dumped in landfill or burned as fuel in manufacturing plants.

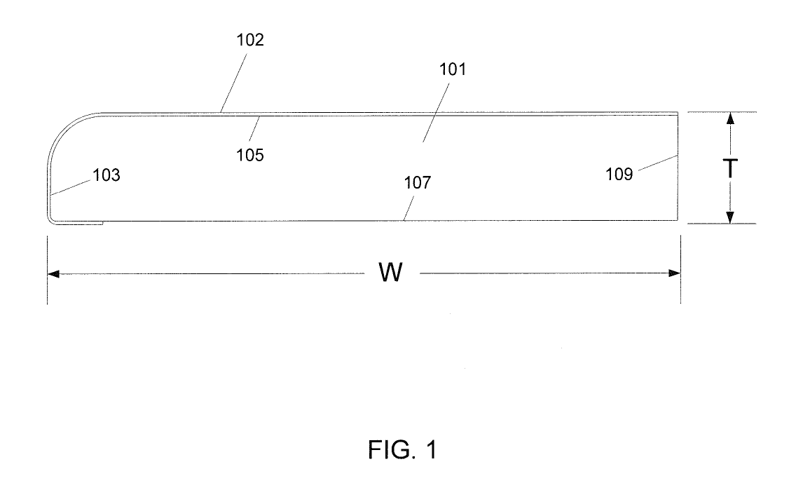

With reference to FIG. 1, a cross section view of an embodiment of the rubber coping 101 is illustrated. The rubber coping 101 can have an inner side 103 that is adjacent to the water of the pool, a planar top surface 105, a planar lower surface 107 and an outer side 109. The rubber coping can have a width W of about 12 to 16 inches and a thickness T of about 1.5 to 3.5 inches. The corner adjacent to the inner edge 103 and the upper surface 105 can have a radius of about coping 101 can have a radius that is about 10 to 50% of the thickness of the coping. The corner adjacent to the inner edge 103 and the lower surface 107 can also have a radius. The radii on the inner edges can provide improve the safety of the rubber coping 101 because all corners are removed from the pool facing side of the coping 101. In other embodiments, the inner corners of the rubber coping 101 can have sharper corners. The softness of the rubber can reduce the chances that these corners will cause injury.

The coping 101 can also be partially or completely covered by a sealer 102 which can provide provides color to the coping 101 and a more stable ultra violet finish. The sealer 102 can be a blend of materials that can include acrylics, urethanes, co-polymers and recycled rubber particles. The sealer 102 can be applied to the coping 101 in liquid form and as the materials dry, the materials can form cross links resulting in a high strength, impact resistant, non-slip, and durable finish. The sealer 102 can be applied with a sprayer or a roller to the coping 101. In an embodiment the sealer 102 may be applied to the coping 101 after all of the coping has been installed in the pool. The sealer may be rolled, sprayed or applied to the coping in a different manner.

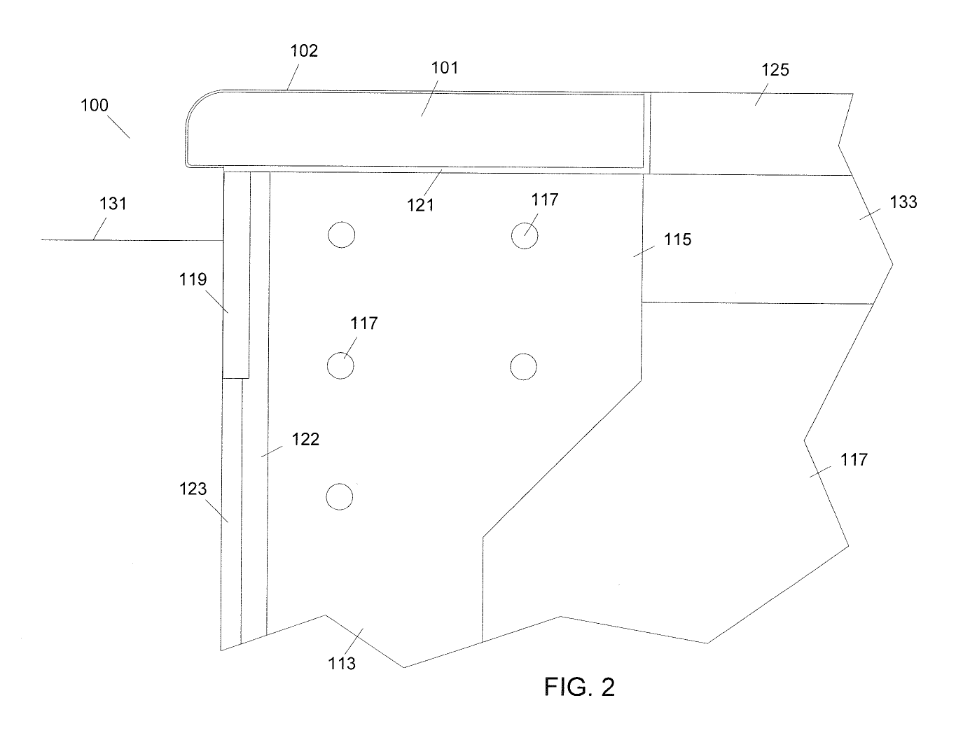

FIG. 2 illustrates a cross section of an embodiment of a portion of a swimming pool 100. The walls 113 of the swimming pool 111 can be composed of a steel reinforced gunite or a shotcrete shell and the walls 113 that are reinforced with rebar 117. The walls 113 can have a brown coat 122 of cement and the inner surfaces 123 of the pool walls 113 can be marbelite plaster which is a cement based coating which may be whitecoat or marcite. The waterline 131 of the pool 111 can be finished with a perimeter band of tiles 119. The top section of the pool wall 103 can expand in thickness and this portion can be called the bond beam 115. The bond beam 115 can have a larger width than the lower portion of the wall 103 and can be about 10 to 12 inches. The coping 101 is attached to the top of the bond beam and the larger width can provide additional strength and surface area for supporting the coping 101. The pool 100 can be an in ground structure that is surrounded by dirt 117. A layer of sand, gravel or clean fill 127 can be placed over the dirt 117. A concrete pool deck 125 can be poured over the layer of sand, gravel or clean fill 127.

The rubber coping 101 can be glued to the upper portion of the bond beam 115 and the top of the tile 119 with a bonding agent 121. With the inner edge of the coping 101 either flush or overhanging the inside wall 103 of the pool 100. In an embodiment the bonding agent 121 can be a polyurethane material such as diphenylmethane diisocyanate (MDI) which can be aromatic or non-aromatic. In other embodiments, other binding agents can be used. The bonding agent 121 can also be used to attach the coping 101 to the pool deck 125. In an embodiment, the width of the coping can be about 14 inches and the maximum over hang over the water can be about 2 inches. This over hang can be important because it can allow a pool over track system to be installed under the coping. The track for a “walk on pool cover” can be installed on the bottom surface of the coping with stainless steel screws.

The described construction is substantially different than a pool built with a normal concrete coping. When a concrete coping is used, the top surface of the bond beam 115 must be covered with a cap leveling mud must be applied over the bond beam 115 and allowed to fully cure and dry. The concrete coping is then attached to the bond beam 115 with a mortar bed must applied over the cap leveling mud. The space between the concrete coping and the concrete pool deck 125 must be filed with an elastic expansion joint material and the space between the top of the tile 119 and the bottom of the concrete coping must be filled with grout or caulk. Both the expansion joint and the grout or caulk will normally crack and fail over time and must be replaced periodically. In contrast, because the rubber coping 101 is elastic, it does not require an expansion joint or caulking. This results in the rubber coping 101 having a substantially simplified installation process.

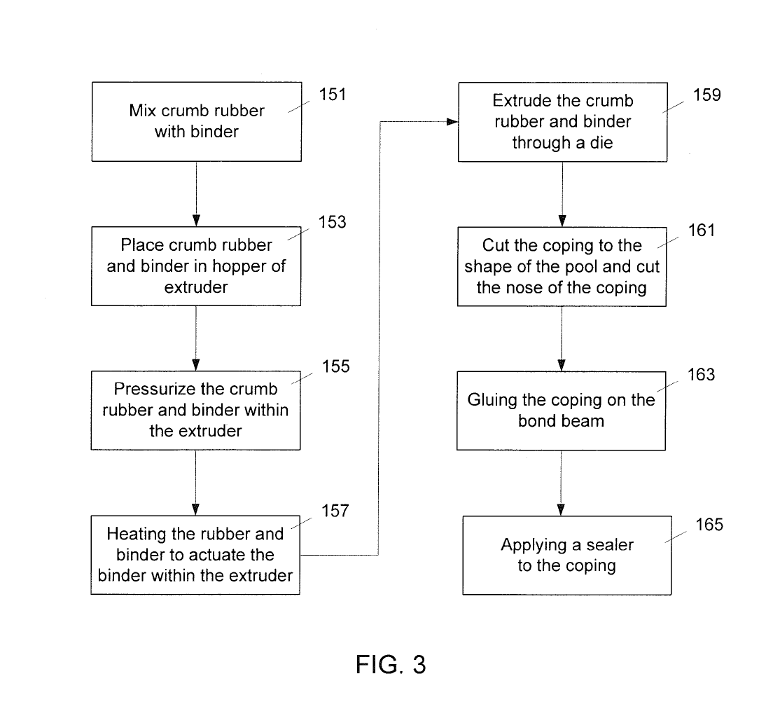

The rubber coping can be manufactured using an extrusion machine in a process that is illustrated in the flowchart shown in FIG. 3. A mixture of crumb rubber having a chip size of 10-30 MB, a small percentage of buffing crumb rubber and a binder can be mixed together 151. In an embodiment, the percentage of crumb rubber is about 95 to 99% granulated rubber and the remaining percentage of polymer binder is about 5 to 1%. The crumb rubber can be 97% and the polymer binder can be 3% of the total materials. The moisture connect of the crumb rubber prior to going into the extruding machine can be between about 0.02 and 0.05%.

These mixed rubber and binder can then be placed into a hopper of an extrusion machine 153. The ambient moisture content can be reduced to about 0.02%. The rubber and binder flow from the hopper into a screw mechanism that can have rotate and compress the rubber and binder in the extrusion machine to a pressure of about 2,000 to 3,000 PSI 155. The pressurized rubber and binder are then forced through a die to extrude the rubber 157. The extruded rubber can have a cross section shape that matches or slightly larger than the cross section of the final rubber coping product, as shown in FIGS. 1 and 2. The combination of high pressure extrusion in excess of 2,000 psi and microwave heating can quickly cause the binder to be activated which improves the cycling time for manufacturing the rubber coping pieces.

While the rubber and binder are in the extruder, this mixture can be heated to a temperature of about 200 to 280 degrees Fahrenheit (F) to activate the binder material which can cause the binder to fuse to the crumb rubber particles together 157. In an embodiment, the coping pieces can be heated by exposing the coping to microwave energy within the extruder. In other embodiments, other heating methods can be used. The heated rubber and binder mixture is then extruded through a die which can be the cross section of the finished coping or slightly larger. For example, the nose portion of the extrusion die may be slightly larger than the finished nosing so that various styles of nosing can be formed on the coping after extrusion. Thus, fewer dies may be able to produce many different styles of coping. As the rubber coping is extruded or after extrusion, a cutter can cut the coping to the desired lengths as required by the installation 159. For example, the extruded rubber can be cut at about 24 inch intervals so that the coping pieces are uniform in length.

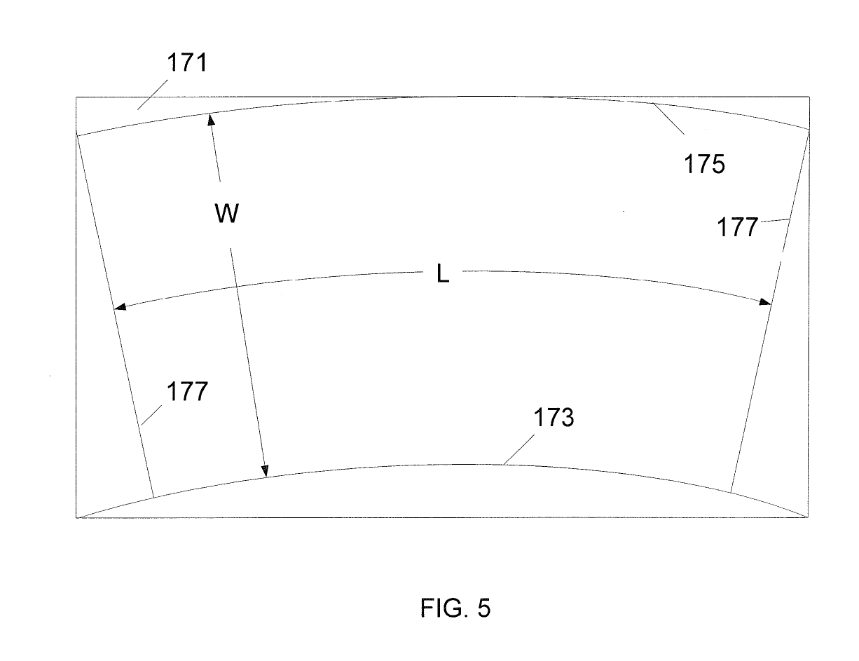

After heating and extrusion, the binder can cool and rigidly bond the crumb rubber chips can be rigidly bonded together to form a strong rubber structure. The rubber coping can then be cut to the required shape 161. With reference to FIG. 5, if a curved coping piece is being made, the extruded rubber 171 is cut to the required radius of the pool with a concave inner radius 173 and an outer convex radius 175. The edges 177 can also be cut to be perpendicular to the inner radius 173 and the outer radius 175. The width “W” of the cut curved coping can be the same as the width of straight coping pieces so that when the coping pieces are installed, the widths will be uniform. The curved length “L” along the center line of the curved coping piece can match the length of the straight coping pieces or be a different length. With reference to FIG. 3, the rubber coping pieces can be cut with a saw or other cutting machine which is capable of precisely cutting the required curves 159.

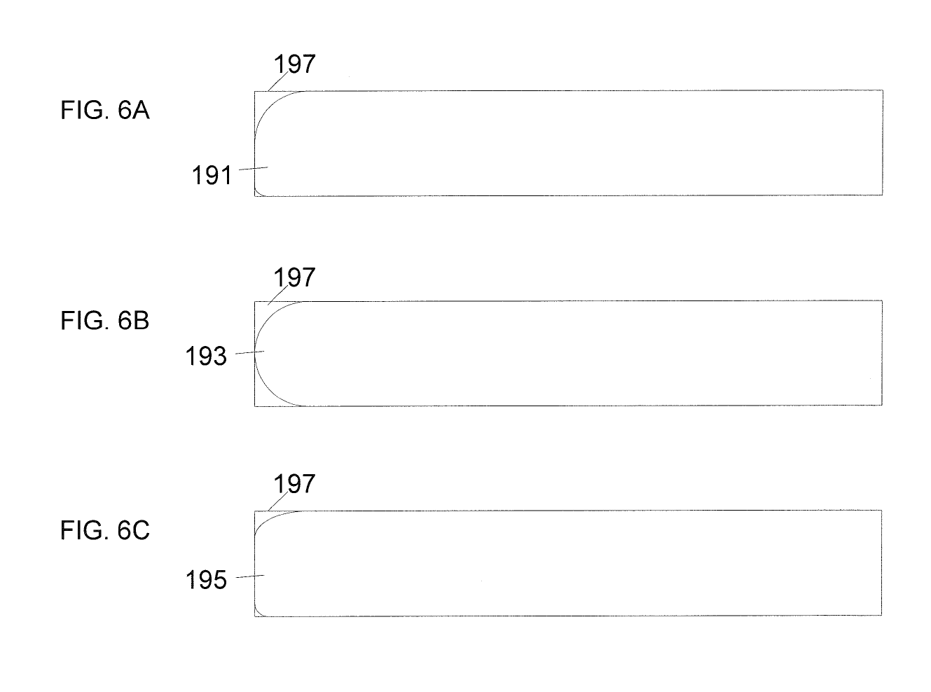

After the coping pieces are cut to the required shape, the nosing of the coping can be formed 161. With reference to FIGS. 6A, 6B and 6C, cross sections of various different nosing shapes 191, 193 and 195 are illustrated as cut lines within the rectangular extruded cross section 197. In order to produce the desired nosing, the rubber coping can be machined by a CNC router table which cuts the specific nosing is cut on the water side of the rubber coping. The router bit can have a cutting blade which matches a portion or all of the desired nosing. In an embodiment, the upper portion of the nosing and the lower portion of the nosing are cut in separate router runs. In other embodiments, the upper and lower portions of the nosing are cut simultaneously. The noising shape can be based upon personal preference, comfort and safety. By removing all sharp corners, people are less likely to be injured in the event of a fall on this surface. The smooth rounded nosing can also provide a comfortable surface to grab onto when holding onto the edge of the pool or pulling on when exiting the pool.

The hardened finished rubber coping pieces can be adhesively bonded to the bond beam on the top edge of the pool wall 163. An adhesive can be placed on the bond beam and the corresponding coping pieces can be placed on the bond beam. In an embodiment, the adhesive used to bond the coping to the bond beam can by a polyurethane such as diphenylmethane diisocyanate (MDI) which can be aromatic or non-aromatic and will not crack. In other embodiments, other suitable adhesives can be used. Depending upon the desired configuration, the water side of the coping can be positioned to be flush with the wall of the pool. Alternatively, the water side of the coping can be placed over the inner wall of the bond beam with an overhang of up to about two inches. The coping pieces can be set sequentially around the top edge of the bond beam the pool. The adhesive can be placed on the side edges of the coping pieces as well to join the adjacent rubber coping pieces. The seam between the adjacent coping pieces can appear to be like a grout line. However, grout is not used in the rubber coping installation.

Gravel or other filler material may be against the outside of the bond beam. Thus, if the rubber coping is wider than the bond beam, the rubber coping may partially rest upon gravel around the outer portion of the bond beam. The gravel may need to be about a minimum of approximately two inches deep and may need to provide a sufficient contact surface to properly support the overlaying rubber coping. Compaction concerns for the gravel may not exist due to the elasticity of the finished rubber coping.

The hardened and installed rubber coping can then be covered with a rubber acrylic sealer that provides UV protection and may also includes an ornamental color 165. The sealer can be applied with an air gun or rollers and will adhere with the bonded rubber substrate of the coping. The sealer can cover and colored sealer can also conceal any seams in the rubber coping. An entire coping in a uniform color can create the appearance of a uniform structure. In an embodiment, the sealer can include small rubber particles which can provide a non-skid surface finish.

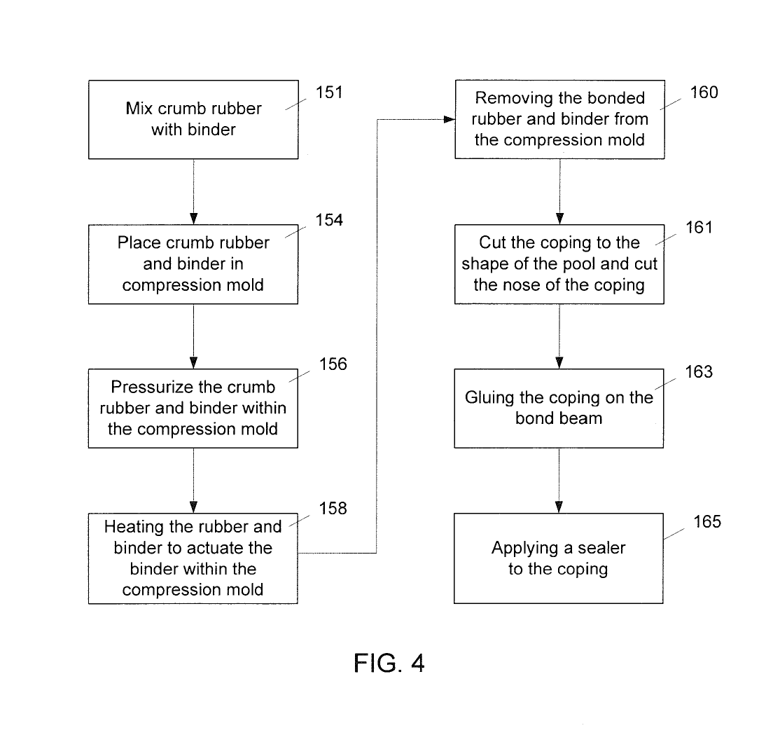

In an alternative embodiment, the rubber coping pieces can be formed through a compression molding process rather than being extruded. With reference to FIG. 4, a flow chart for the fabrication process that uses compression molding is illustrated. Several of the process steps are the same as discussed above with reference to FIG. 3. A mixture of crumb rubber, a buffing crumb rubber and a binder can be mixed together 151. In an embodiment, the percentage of crumb rubber is about 95 to 99% granulated rubber and the remaining percentage of polymer binder is about 5 to 1%.

The rubber and binder mixture can be placed in a lower compression mold which can have an open top 154. Once the lower mold is filled with the proper volume of uncompressed rubber and binder materials, the upper mold can then be pressed into the lower mold to compress the rubber with pressure 156. In an embodiment, the compression ratio can be 2:1 meaning that the mold can have an initial volume that is twice the compressed volume. In other embodiments, the compression mold can have a different compression ratio.

The pressure applied by the upper mold can be greater than 250 psi. The rubber and binder can also be heated within the compression mold 158. The heat applied to the rubber and binder mixture in the mold can be about 200 to 280 degrees Fahrenheit (F) for a period of about 16 minutes. The heat can activate the binder material which can cause the binder to fuse to the rubber particles together. The heat can be applied to the compression mold through a regular heat source such as electrical heating elements or natural gas burners. A temperature sensor can be used to regular the electricity applied to the heating element or the flow rate of natural gas to the compression mold.

After compression molding, the coping pieces can be removed from the mold and cooled to harden the binder and adhered to the rubber particles 160. The mold can be rectangular or curved in horizontal cross section and may be close to the final size of the rubber coping pieces. In other embodiments, the mold can be over sized and the rubber coping may have to be cut to the required coping shape and a nose can be cut on the coping 161 as discussed and illustrated above in FIGS. 5 and 6A-6C.

The hardened rubber coping pieces can be adhesively bonded to the bond beam on the top edge of the pool wall and the adjacent coping pieces with an adhesive 163 as described above. The installed rubber coping can then be covered with a rubber acrylic sealer that provides UV protection and may also includes an ornamental color 165 as described above to complete the rubber coping installation.

It will be understood that the inventive system has been described with reference to particular embodiments, however additions, deletions and changes could be made to these embodiments without departing from the scope of the inventive system. Although the order filling apparatus and method have been described include various components, it is well understood that these components and the described configuration can be modified and rearranged in various other configurations.

What is claimed is:

1. A method for making a swimming pool coping comprising:
mixing granulated rubber and a polymer binder;
pressurizing the granulated rubber and polymer binder;
reacting the polymer binder to bond the granulated rubber;
extruding the granulated rubber and the polymer binder through a die; and
cutting the granulated rubber after extruding to form the swimming pool coping.

2. The method of claim 1 wherein in the mixing step, the percentage of crumb rubber is about 95 to 99% granulated rubber and the percentage of polymer binder is about 1 to 5%.

3. The method of claim 1 wherein during the pressurizing step, the granulated rubber and polymer binder are pressurized to more than 250 psi.

4. The method of claim 1 wherein the cutting step comprises:
cutting a first side of the swimming pool coping to create a concave side; and
cutting a second side of the swimming pool coping opposite the first side to create a convex side.

5. The method of claim 4 further comprising:
cutting a third side adjacent to the first side and the second side and cutting a fourth side adjacent to the first side and the second side to create straight sides.

6. The method of claim 1 wherein the reacting step includes exposing the polymer binder to microwave energy.

7. The method of claim 1 wherein the reacting step include heating the polymer binder to a temperature between about 200 and 280 degrees F.

8. The method of claim 1 wherein the polymer binder is a MDI polyurethane binder.

9. The method of claim 1 wherein the rubber is recycled rubber from tires.

10. The method of claim 1 further comprising:
applying a rubber acrylic sealer on an upper surface to the swimming pool coping to increase the UV stability of the swimming pool coping.

11. The method of claim 1 further comprising:
applying a rubber acrylic sealer having a colored pigment on an upper surface to the swimming pool coping to color the swimming pool coping.

12. A method for making a swimming pool coping comprising:
mixing granulated rubber and a polymer binder;
pressurizing the granulated rubber and polymer binder;
reacting the polymer binder to bond the granulated rubber;
extruding the crumb rubber and the polymer binder through a die;
cutting the granulated rubber after extruding to form the swimming pool coping; and
adhering the swimming pool coping on a bond beam of a swimming pool.

13. The method of claim 12 wherein the cutting step comprises:
cutting a first side of the swimming pool coping to create a concave side; and
cutting a second side of the swimming pool coping opposite the first side to create a convex side.

14. The method of claim 13 further comprising:
adhering the swimming pool coping to a second swimming pool coping on the bond beam of the swimming pool.

15. The method of claim 12 wherein during the pressurizing step, the granulated rubber and polymer binder are pressurized to more than 250 psi.

17. The method of claim 12 wherein the reacting step includes exposing the polymer binder to microwave energy.

18. The method of claim 12 wherein the reacting step include heating the polymer binder to a temperature between about 200 and 280 degrees F.

19. The method of claim 12 further comprising:
applying a rubber acrylic sealer on an upper surface to the swimming pool coping to increase the UV stability of the swimming pool coping.

20. The method of claim 12 further comprising:
applying a rubber acrylic sealer having a colored pigment on an upper surface to the swimming pool coping to color the swimming pool coping.
